(19) United States
(12) Patent Application Publication
(10) Pub. No.: US 2004/0059709 A1
(43) Pub. Date: Mar. 25, 2004

(54) Management process implementation system and method

(76) Inventors: Donald Farrands, Victoria (AU); Stewart Anderson, Victoria (AU); Scott McGregor, Victoria (AU); Luke Reinehr, Victoria (AU)

Correspondence Address: Scully Scott Murphy & Presser, 400 Garden City Plaza, Garden City, NY, 11530, US

(21) Appl. No.: 10/381,290

(22) PCT Filed: Sep. 21, 2001
(86) PCT No.: PCT/AU01/01192

(30) Foreign Application Priority Data
Sep. 21, 2000 (AU) PR0286

(51) Int. Cl. G06F 7/00

(52) U.S. Cl. 707/1

(57) ABSTRACT

A system and method for implementation of management processes uses a central controller (2) which processes program instructions to display on a terminal (3) series of activities for achieving category goals. Selection of an activity results in related activity information being displayed on the terminal for verification of implementation. The central controller (2) periodically transmits performance information to the terminal to allow auditing of the performance against the category goals.

### FIELD OF THE INVENTION

The present invention relates generally to systems and methods for the implementation of management processes, and in particular to management processes that require the performance of a series of selected activities intended to achieve organisation dependent goals. The present invention is suitable for use in the implementation of an environmental management system, and it will be convenient to hereinafter to describe the invention in relation to that exemplary, but non limiting application.

### BACKGROUND OF THE INVENTION

The International Organisation for Standardisation (ISO) has developed a series of voluntary generic standards that provide business management with a structure for managing environmental impacts. ISO Standard No. 14001 describes a model for an environmental management system that enables organisations to control the impact of environmental issues relevant to their business activites. As is the case in many management processes, implementation of the environmental management system defined by ISO Standard No. 14001 requires the performance of various activities or tasks to achieve environmental goals defined by the organisation, and monitoring the performance of these tasks in achieving these goals.

Due to the complexity of the steps involved however, very few organisations have implemented this environmental management system to date. Those organisations that have implemented this system have usually relied upon expensive consultants to assist them in the implementation process.

It would therefore be desirable to provide a means of facilitating the implementation of such an environmental management system or like management process that is convenient, simple and cost effective.

### SUMMARY OF THE INVENTION

With this in mind, the present invention provides, in one aspect, a method of implementing a management process using a central controller including processing means and a memory operatively connected to the processing means and containing a program adapted to be executed by the processing means, and a terminal adapted for communicating with the central controller, the method comprising the steps of:

displaying at the terminal a series of activities intended to achieve organisation-dependant goals in one or more categories;

selecting at the terminal one or more of said activities and transmitting corresponding selected activity information to said central controller;

periodically transmitting said selected activity information from the central controller for display at the terminal to enable verification that the selected activities have occurred;

detecting at the central controller that verification has taken place at the terminal;

periodically transmitting performance assessment information from the central controller for display at the terminal to enable auditing the performance of said management process in meeting said goals, and

detecting at the central controller that the auditing has taken place at the terminal.

In one embodiment of the invention, the management process enables the organisation to implement an environmental management system, such as the International Organisation for Standardisation (ISO) Standard No. 14001.

The categories may include environmental issues impacting the organisation.

The goals may relate to controlling the impact of an environmental issue.

The activities may include tasks for achieving one or more goals.

Conveniently, the central controller and the terminal may be remotely interconnectable via a computer network, such as the Internet.

According to another aspect of the invention there is provided a management process implementation system comprising:

a central controller including processing means and a memory operatively connected to the processing means, and

terminal adapted for communicating with the central controller and acting to display a series of activities intended to achieve organisation-dependant goals in one or more categories;

means to enable the selection of one or more said activities and transmit corresponding selected activity information to said central controller;

said memory in said central controller containing a program, adapted to be executed by the processing means, for periodically transmitting said selected activity information from the central controller for display at the terminal to enable verification that the selected activities have occurred;

detecting that verification has taken place at the terminal; periodically transmitting performance assessment information from the central controller for display at the terminal to enable auditng the performance of said management process in meeting said goals, and

detecting that the auditing has taken place at the terminal.

According to a still further aspect of the invention there is provided a computer program element comprising:

computer program code means to enable a central controller to receive selected activity information corresponding to one or more selected activities intended to achieve organisation-dependant goals in one or more categories, and

to enable the central controller to periodically transmit said selected activity information for display at a terminal to enable verification that the selected activities have occurred;

detect that verification has taken place at the terminal;

periodically transmit performance assessment information for display at the terminal to enable auditing the performance of said management process in meeting said goals, and

detect that the auditing has taken place at the terminal.

The invention also provides a computer readable memory, encoded with data representing a computer program, that can be used to direct a central controller to receive selected activity information corresponding to one or more selected activities intended to achieve organisation-dependant goals in one or more categories, and

to enable the central controller to periodically transmit said selected activity information for display at a terminal to enable verification that the selected activities have occurred;

detect that verification has taken place at the terminal; periodically transmit performance assessment information for display at the terminal to enable auditing the performance of said management process in meeting said goals, and

detect that the auditing has taken place at the terminal.

The following description refers in more detail to the various features of the present invention. To facilitate an understanding of the invention, reference is made in the description to the accompanying drawings where the management process implementation method and system are illustrated in a preferred embodiment. It is to be understood, however, that the invention is not limited to the preferred embodiment as illustrated in the drawings.

### DESCRIPTION OF THE DRAWINGS

In the drawings:

FIG. 1 is a schematic diagram illustrating one embodiment of a management process implementation system according to the present invention;

FIG. 2 is a flow diagram illustrating the process flow involved in tailoring the management process implementation system of FIG. 1 to a specific user;

FIGS. 3 to 7 arm diagrams illustrating information displayed to a use during the process illustrated in FIG. 2;

FIGS. 8, 9 and 10 are flow diagrams illustrating the process flow involved in review processes enabled by the management process implementation system of FIG. 1; and

FIG. 11 is a diagram illustrating information presented to the user during the review process shown in FIG. 9.

### DESCRIPTION OF THE PREFERRED EMBODIMENT

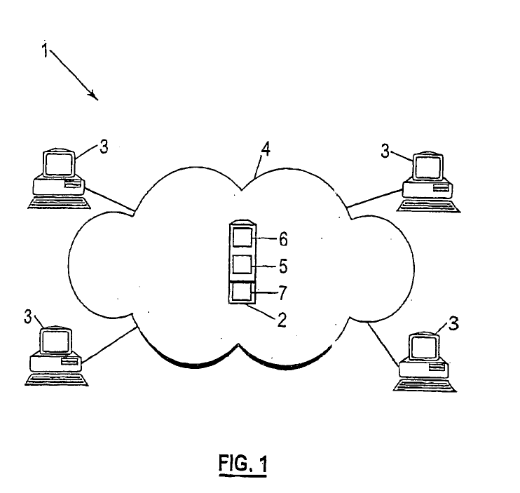

Referring to FIG. 1, there is shown generally a computer network 1 implementing one embodiment of a management process implementation system according to the present invention. The computer network 1 includes a central controller 2 and at least one remote terminal 3. In this example, the remote terminal 3 and the central controller 2 are interconnected by the Internet. In other embodiments, the terminal 3 and the central controller 2 may be interconnected by other means, including being physically housed in the one computing device. The central controller 2 includes processing means 5 and a memory 6 operatively connected to the processing means and containing a computer program adapted to be executed by the processing means, for enabling the functionality of the management process implementation system. The central controller 2 further includes a data storage area 7 in which are stored data files accessed by the processing means 5 during the execution of the program stored in the memory 6. Typically, the central controller may be a file server forming part of the Internet, and the data and program stored in the memory devices 6 and 7 may consist of files hosted at that server. The management process implementation system in this example is enabled by the series of steps executed by the central controller 2 and the interaction of a remote user via the terminal 3.

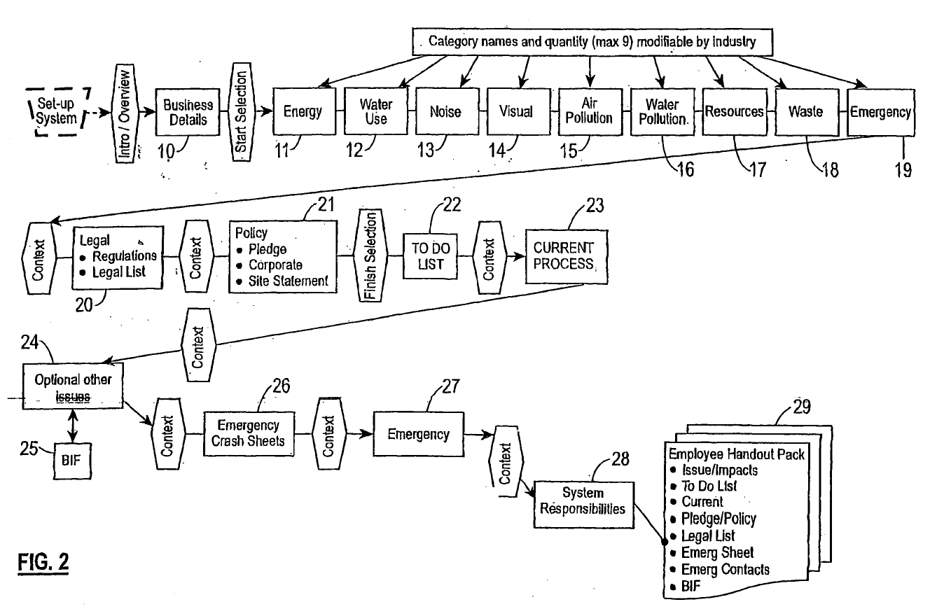

In order to establish an environmental management system, or other like management process implementation system, a user firstly goes through a number of consecutive steps in order to tailor the system to the specific characteristics of his organisation. As seen in FIG. 2, a user is initially required at step 10 to enter administrative data related to their business organisation. Such information may include the name of key contacts within that organisation and information identifying the nature of the business conducted by that organisation.

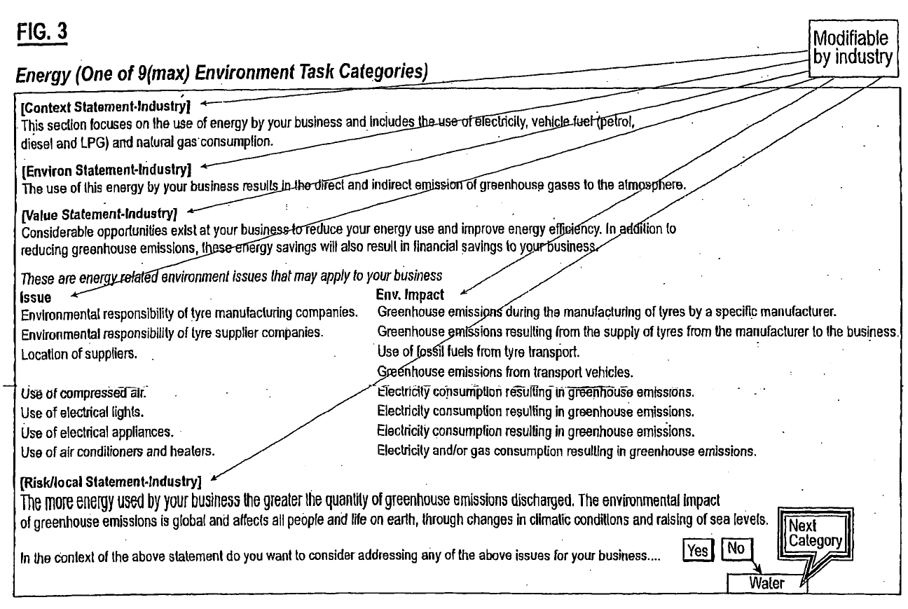

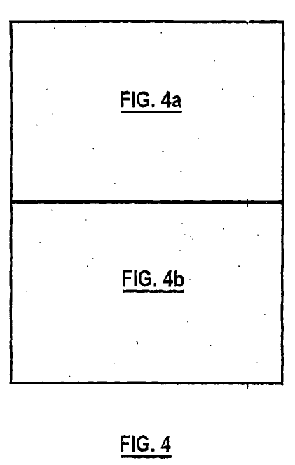

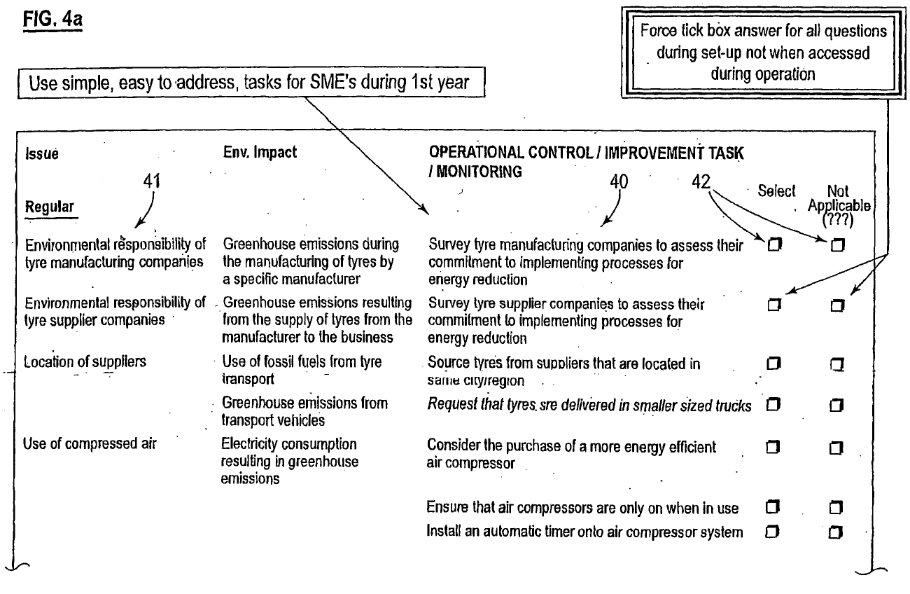

At steps 11 go 19, information is transmitted from the central controller 2 to the remote terminals 3 to enable the display of various environmental categories which may impact the organisation, and a series of activities or tasks in each category intended to the achieve the goals of an organisation in minimsing the environmental impact of its business operations in that category. An example of the information displayed in steps 11 to 19 is shown in FIG. 3. In this instance, the environmental category is “energy”. Energy related environmental issues and the environmental impact of those issues that may apply to a user's organization are initially displayed If the user considers that his organisation is affected by any of these issues, he is then able to access a further display, as shown in FIG. 4. This further display notably indicates a series of tasks or activities 40 related to the environmental issues 41 identified as having an environmental impact from the previous screen.

Check boxes 42 are provided on this screen in order to enable the user to select one or more of these activities as a task to be monitored by the environmental management system Tasks to be monitored from each of the nine environmental categories 11 to 19 are sequentially selected in this manner.

Following task selection, a list of legislation relevant to the user's organisation is displayed at step 20. In addition, a table may be displayed to enable the user to create a list of activities which must and which must not be performed in order to meet the legal requirements of the legislation in the relevant jurisdiction. This list is able to be modified by the user.

At step 21, a policy overview page is displayed at the terminal 3 to enable the creation of a corporate policy and pledge committing the organisation to desired levels of environmental commitment and performance. The organisation's policy is automatically generated once the user has responded to questions relating to the level of environmental commitment, performance and improvement processes desired by his organisation. After the questions have been answered, a policy is automatically generated by the central controller 2 using generic environmental performance and system goals and also specific industry related goals stored in the memory 7 of the central controller 2.

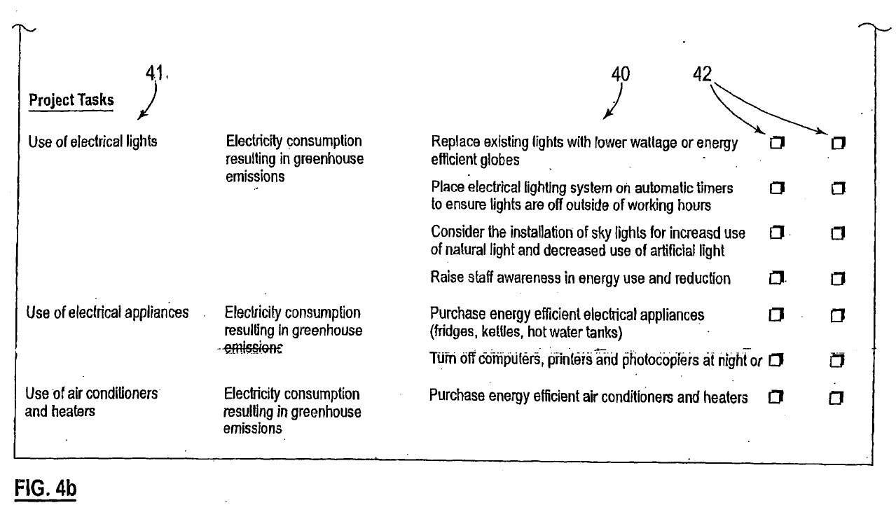

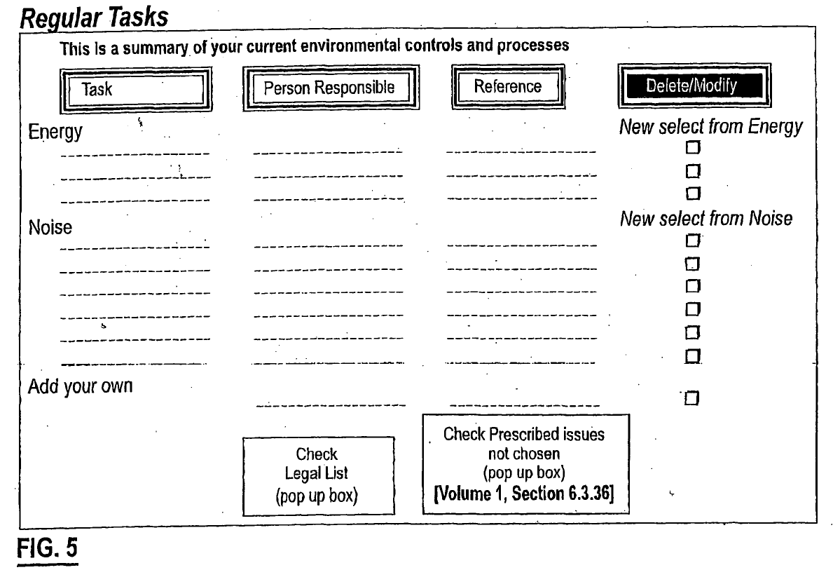

At step 22, a list of all control tasks selected in steps 11 to 19 is presented to the user for review, and enables the assignment of a responsible person from within the user's organisation and a reference to each task. An Example of the information displayed in step 22 is shown in FIG. 5.

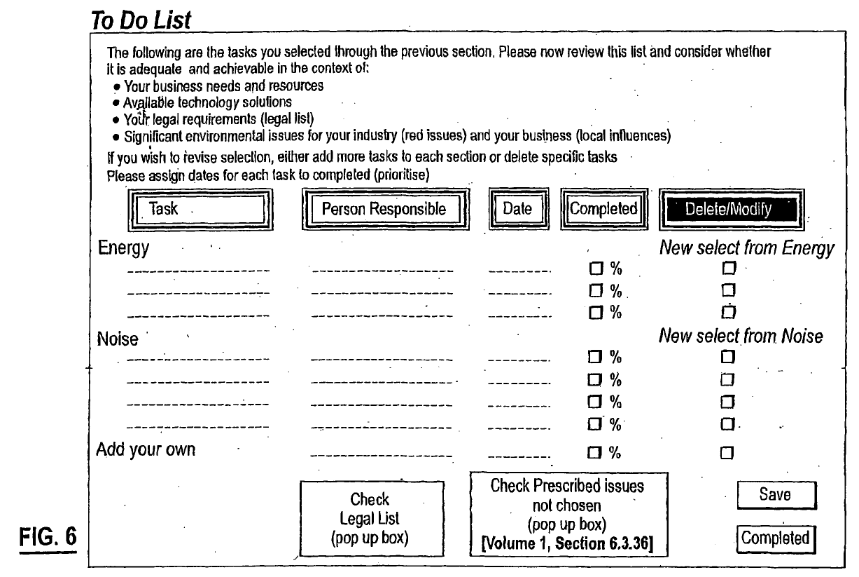

At step 23, project tasks that have been selected by the user at steps 11 to 19 are displayed and the user is provided with the opportunity of assigning a responsible person, target completion date and percentage complete indicator against each of the selected tasks. An example of the information displayed to the user at this step is shown in FIG. 6. The information displayed in FIGS. 5 and 6 is able to be modified by the user.

In step 24, optional additional details may be addressed by the user, including the generation of business improvement forms at step 25 for future use in the improvement of the organisation's business operations.

At step 26, an emergency response sheet overview page is displayed to the user to enable the creation of a list of crash sheets. A crash sheet is a set of instructions that art to be followed in an emergency. Each emergency response sheet may have a series of instruction and a guide notice associated with each instruction as to the appropriate action to take in the case of an emergency. A series of emergency contact details are able to be entered by the user in step 27, such as the local fire brigade, ambulance, police and poisons information phone numbers.

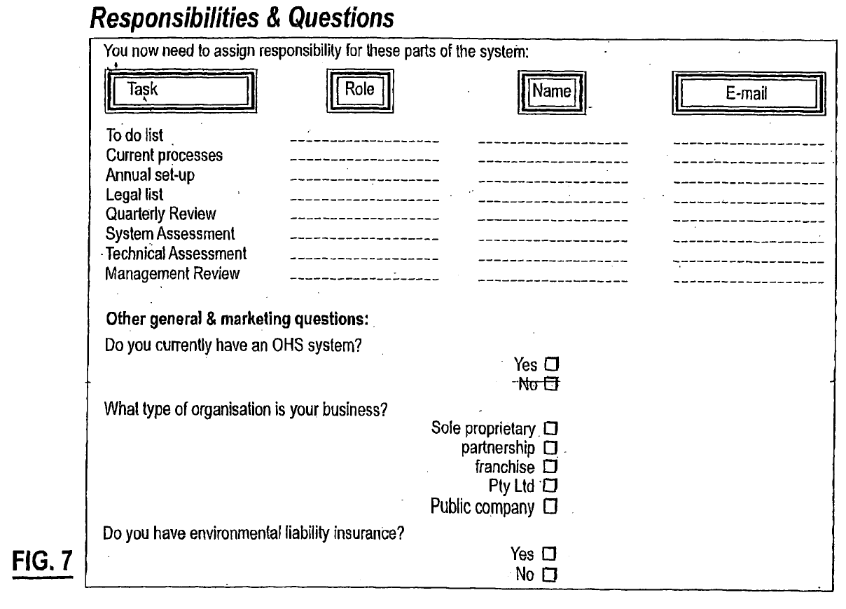

At step 28, the user is presented with a screen requiring the entry of individuals and their e-mail or other contact details to enable the control and auditing of the tasks defined during the set up process shown in FIG. 2 to take place. An example of the information displayed to the user at this step is shown in FIG. 7. Accordingly, individuals can be assigned responsibility for each of the various review processes required by the environmental management system.

At step 29, the information collected in the previous steps of the set up process is collated into an employee information pack page. This page includes text explaining the us of the employee information pack and displays links to enable the issue/impact summary page, project task list, regular task list, corporate and site policy, corporate and site pledge, legal do/do not list, crash sheets, emergency contacts, business improvement forms and owners fact sheet to be printed. This printed information can then be distributed to relevant employees within the user's organisation for use in the performance and monitoring of the tasks defined during the set up process shown in FIG. 2. At the completion of the process shown in this figure, an e-mail or other like communication is forwarded to a central administrator advising that the organisation has now set up the basis of an environmental management system and defined tasks that are to be performed in order to comply with this system.

An integral part of the management process implementation system according to the present invention relates to the verification that the tasks previously defined have occurred, and the auditing of the performance of the management process system in meeting the goals defined by the user's organisation. Accordingly, the central controller provides an e-mail to the system administrator and the user at periodic intervals to prompt the user to verify that the selected tasks have occurred Typically, reviews may take place at least quarterly, with a management review taking place at least annually. In addition, an annual review of the set up defined in FIG. 2 may be scheduled to allow the organisation to work through the set up process again, in order to review all existing data maintained in the central controller 2.

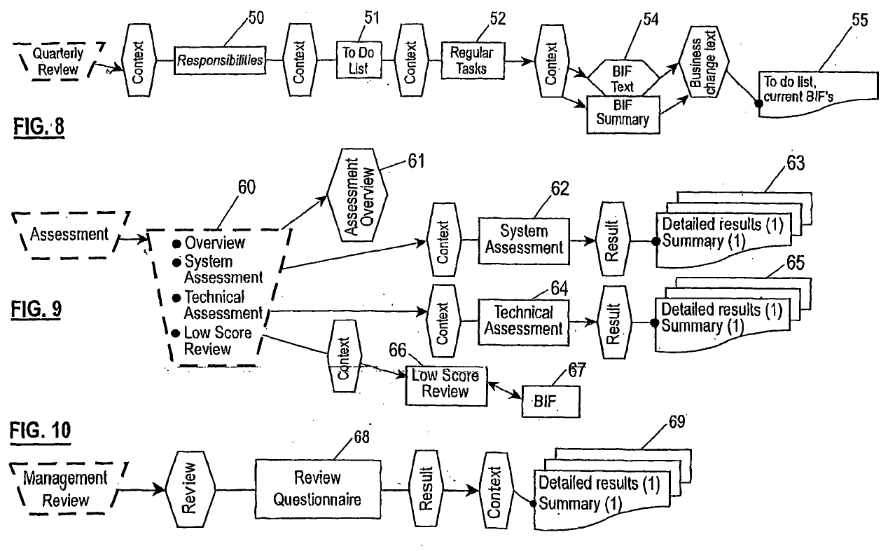

FIG. 8 illustrates the steps which may be involved in the quarterly review of the environmental management system. In step 50, the assigned system responsibilities page is retrieved from the central controller 2 and displayed to the user in order to confirm that appropriate individuals are responsible for each of the system administration tasks. At steps 51 and 52, lists of regular and project tasks illustrated in FIGS. 5 and 6 are once again displayed to the user. The user then proceeds to verify that the tasks identified in steps 50 to 52 have been performed by those individuals responsible for these tasks. At step 53, the user is progressed through the business improvement form summary page so that any relevant environmental information acquired during the verification process enabled by steps 50 to 52 can be used to take action in improving the business processes of the organisation. At step 55, the updated list of tasks to be performed shown in FIGS. 5 and 6 is again printed for future use in the monitoring of these tasks.

Referring now to FIG. 9, there is shown the review process flow to enable the audit of the environmental management system to take place. Prior to the scheduled audit process, the Ventral controller 2 acts to send an e-mail reminder to the user requesting that this process be completed When the user requests that the periodic audit process is to occur via the terminal 3, the central controller returns information enabling the display at the terminal 3 of generic information explaining the audit process, as well links to a system review page, technical review page and low score review page at step 60. At step 61, the generic text explaining the audit process is able to be reviewed by the user. By the selection of the link to the system review page, the central controller 2 is caused to transmit performance assessment information for display at the terminal 3 to enable auditing of the performance of the environmental management system in meeting the environmental goals previously defined in the set up process shown in FIG. 2. Accordingly the user is presented at step 62 with a series of questions generic across all industries and multiple possible responses for each question.

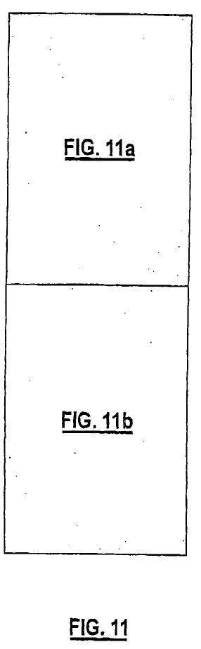

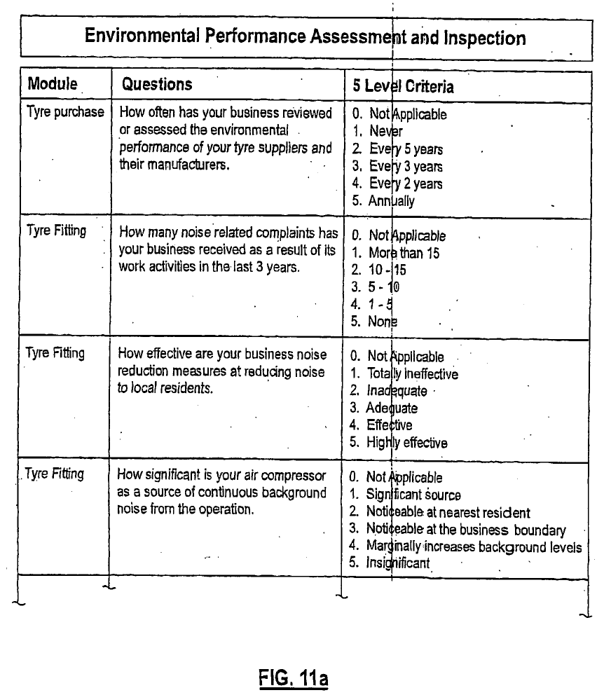

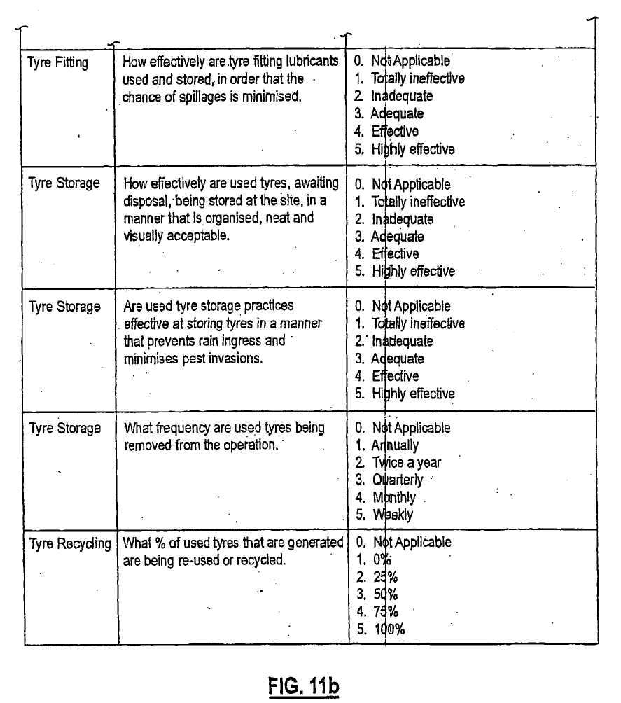

An example of the questions and possible responses is shown in FIG. 11. In addition, text entry fields are provided in order to enable details of the reviewer to be entered. Preferably, the reviewer should be a different person to the initial user involved in the set up and quarterly review process, in order to provide some level of independent verification of the performance of the environmental management system. At the conclusion of the system assessment, a system review results page is displayed to the user at step 63. This page includes text information and an overall assessment of the system review. The results from the system review are determined in this example by attributing a points value to each of the possible responses to a particular question that increases with the effectiveness with which the organisation has met its predetermined environmental goals. The overall points value of the responses chosen by the reviewer are then calculated and displayed to the user as a percentage result indicating the performance of the environmental management system

Similarly, selection of the technical review page at step 60 results in the central controller 2 forwarding technical review questions to the terminal 3 for display. Preferably, the technical review questions are customised to match the business activities of the organisation. To that end groups of performance assessment questions customised by industry or association type are stored in the memory device 7 of the central controller 2. The central controller 2 selects the appropriate group of customised questions for display during the audit process according to the information provided by the user during the set up process indicated in FIG. 2. Accordingly, at step 64, technical review questions and multiple possible responses for each question ate displayed to the reviewer. The response to these questions are then used to display a detailed results page to the reviewer at page 65. Once again, the results displayed are calculated as simple percentages from the sum of the point value assigned to the responses chosen by the reviewer.

Upon selection of the low score review page in step 60, the central controller 2 forwards to the terminal 3 a low score review page at step 66. This page lists all questions for which the numerical score was less than a predetermined value, indicating that the performance of the organisation in meeting its predefined and environmental goals in this area has been inadequate. This page also contains a link to the business improvement form page so that at step 67, remedial action can be taken.

The environmental management system also enables and annual review of the performance of the organisation in meeting its environmental goals to be conducted. Prior to each annual review, the central controller 2 forwards and e-mail message or other communication to the organisation reminding that this activity is due. When the annual review is undertaken by the user from the terminal 3, a review questionnaire is forwarded from the central controller 2 to the terminal 31 at step 68. The annual review is comprises of static text information and multiple choice questions. Again, each multiple choice has a point value associated with it. Additionally, text entry fields are provided for the reviewer. Preferably, the reviewer is a physically separate person from the person verifying that the selected environmental tasks have occurred in order to optimise the accuracy of the review results. Once again, the performance of the organisation in achieving its environmental goals is assessed based upon their response to the displayed questions and then displayed to the reviewer at step 69.

It can be seen from the foregoing that the management process implementation system and method according to the present invention enables not only the selection of appropriate tasks by an organisation to meet appropriate environmental or other management goals, but enables both the control and auditing of this management process in a convenient, user friendly manner.

1. A method of implementing a management process using a central controller including processing means and a memory operatively connected to the processing means and containing a program adapted to be executed by the processing means, and a terminal adapted for communicating with the central controller, the method comprising the steps of:
displaying at the terminal a series of activities intended to achieve organisation-dependant goals in one or more categories;
selecting at the terminal one or more of said activities and transmitting corresponding selected activity information to said central controller;
periodically transmitting said selected activity information from the central controller for display at the terminal to enable verification that the selected activities have occurred;
detecting at the central controller that verification has taken place at the terminal;
periodically transmitting performance assessment information from the central controller for display at the terminal to enable auditing the performance of said management process in meeting said goals, and
detecting at the central controller that the auditing has taken place at the terminal.

2. A method of implementing a management process according to claim 1 wherein the managements process enables the organisation to implement an environmental management-system, such as the International Organisation for Standardisation (ISO) Standard No. 14001.

3. A method of implementing a management process according to claim 1 or claim 2 wherein the categories include environmental issues impacting the organisation.

4. A method of implementing a management process according to claim 3 wherein the goals relate to controlling the impact of an environmental issue.

5. A method of implementing a management process according to any one of the preceding claims wherein the activities include tasks for achieving one or more goals.

6. A method of implementing a management process according to any one of the preceding claims wherein the central controller and the terminal are remotely interconnectable via a computer network, such as the Internet.

7. A management process implementation system comprising;
a central controller including processing means and a memory operatively connected to the processing means, and
a terminal adapted for communicating with the central controller and acting to display a series of activities intended to achieve organisation-dependant goals in one or more categories;
means to enable the selection of one or more of said activities and transmit corresponding selected activity information to said central controller;
said memory in said central controller containing a program, adapted to be executed by the processing means, for periodically transmitting said selected activity information from the central controller for display at the terminal to enable verification that the selected activities have occurred;
detecting that verification has taken place at the terminal; periodically transmitting performance assessment information from the central controller for display at the terminal to enable auditing the performance of said management process in meeting said goals, and
detecting that the auditing has taken place at the terminal.

8. A management process implementation system according to claim 7 wherein the management process enables the organisation to implement an environmental management system, such as the International Organisation for Standardisation (ISO) Standard No. 14001.

9. A management process implementation system according to claim 7 or claim 8 wherein the categories include environmental issues impacting the organisation.

10. A management process implementation system according to claim 9 wherein the goals relate to controlling the impact of an environmental issue.

11. A management process implementation system according to any one of claims 7 to 10 wherein the activities include tasks for achieving one or more goals.

12. A management process implementation system according to any one of claims 7 to 11 wherein the central controller and the terminal are remotely interconnectable via a computer network, such as the Internet.

13. A computer program element comprising:
computer program code means to enable a central controller to receive selected activity information corresponding to one or more selected activities intended to achieve organisation-dependant goals in one or more categories, and
to enable the central controller to periodically transmit said selected activity information for display at a terminal to enable verification that the selected activities have occurred;
detect that verification has taken place at the terminal;
periodically transmit performance assessment information for display at the terminal to enable auditing the performance of said management process in meeting said goals, and
detect that the auditing has taken place at the terminal.

14. A computer program element according to claim 13 wherein the management process enables the organisation to implement an environmental management system, such as the International Organisation for Standardisation (ISO) Standard No. 14001.

15. A computer program element according to claim 13 or claim 14 wherein the categories include environmental issues impacting the organisation.

16. A computer program element according to any one of claim 13 to 15 wherein the goals relate to controlling the impact of an environmental issue.

17. A computer program element according to any one of claims 13 to 16 wherein the activities include tasks for achieving one or more goals.

18. A computer program element according to any one of claims 13 to 17 wherein the central controller and the terminal are remotely interconnectable via a computer network, such as the Internet.

19. A computer readable memory, encoded with data representing a computer program, that can be used to direct a central controller to receive selected activity information corresponding to one or more selected activites intended to achieve organisation-dependant goals in one or more categories, and
to enable the central controller to periodically transmit said selected activity information for display at a terminal to enable verification that the selected activities have occurred;
detect that verification has taken place at the terminal; periodically transmit performance assessment information for display at the terminal to enable auditing the performance of said management process in meeting said goals, and
detect that the auditing has taken place at the terminal.

20. A computer readable memory according to claim 19 wherein the management process enables the organisation to implement an environmental management system, such as the International Organisation for Standardisation (ISO) Standard No. 14001.

21. A computer readable memory according to claim 19 or claim 20 wherein the categories include environmental issues impacting the organisation.

22. A computer readable memory according to any one of claims 19 to 21 wherein the goals relate to controlling the impact of an environmental issue.

23. A computer program element according to any one of claims 19 to 22 wherein the activities include tasks for achieving one or more goals.

24. A computer program element according to any one of claims 19 to 23 wherein the central controller and the terminal are remotely interconnectable via a computer network, such as the Internet.

25. A method of implementing a management process using a central controller including the steps hereinbefore described with reference to the accompanying drawings.

26. A management process implementation system substantially as hereinbefore described with reference to the accompanying drawings.
